(19) United States
(12) Patent Application Publication
(10) Pub. No.: US 2025/0006926 A1
(43) Pub. Date: Jan. 2, 2025

(54) NEGATIVE ACTIVE MATERIAL AND RECHARGEABLE LITHIUM BATTERY INCLUDING SAME

(71) Applicants: SAMSUNG SDI CO., LTD., Yongin-si (KR); UNIVERSITY-INDUSTRY COOPERATION GROUP OFKYUNG HEE UNIVERSITY, Yongin-si (KR)

(72) Inventors: Ilyoung CHOI, Yongin-si (KR); Min-Sik Park, Yongin-si (KR); Sungmin Park, Yongin-si (KR); Taehee Kim, Yongin-si (KR); Deok-Hyun Kim, Yongin-si (KR); Youngugk Kim, Yongin-si (KR); Jaehou Nah, Yongin-si (KR); Joo Hyeong Suh, Yongin-si (KR)

(21) Appl. No.: 18/679,644

(22) Filed: May 31, 2024

(30) Foreign Application Priority Data
Jun. 28, 2023 (KR) 10-2023-0083709

(51) Int. Cl. H01M 4/583; C01B 21/06; H01M 4/02; H01M 4/04; H01M 4/38; H01M 10/0525

(52) U.S. Cl. CPC H01M 4/583; C01B 21/0605; H01M 4/0471; H01M 4/386; H01M 10/0525; H01M 2004/027

(57) ABSTRACT

A negative active material and a rechargeable lithium battery including the same, the negative active material including a core including a carbon material; and a carbon nitride on a surface of the core, and the rechargeable lithium battery including a negative electrode including the negative active material; a positive electrode; and an electrolyte.

### CROSS-REFERENCE TO RELATED APPLICATION

This application claims priority to and the benefit of Korean Patent Application No. 10-2023-0083709 filed in the Korean Intellectual Property Office on Jun. 28, 2023, the entire contents of which are incorporated herein by reference.

### BACKGROUND

### 1. Field

Embodiments relate to a negative active material and a rechargeable lithium battery including the same.

### 2. Description of the Related Art

In order to manage climate changes, fuel economy regulations and mandatory introduction of electrical vehicles are being implemented worldwide, and the demand for electric vehicles is gradually increasing. For increasing the driving range of electric vehicles, research has been mainly conducted to improve energy density of the rechargeable lithium batteries. However, to widely spread electric vehicles, shortening charging times is essential. Therefore, there is an urgent need to develop a rechargeable lithium battery capable of rapidly charging.

### SUMMARY

Embodiments are directed to a negative active material, including a core including a carbon material; and a carbon nitride on a surface of the core.

The carbon nitride may be represented by Chemical Formula 1,

CₓN_{y} [Chemical Formula 1]
wherein 0<x<6 and 0<y<5.

The carbon nitride may include C₃N₄, CN, C₂N, C₃N, C₂N₂, C₂N₃, C₅N, C₅N₂ or a combination thereof.

An amount of the carbon nitride may be about 2 wt % to about 20 wt %, based on a total weight of the negative active material.

An amount of the carbon nitride may be about 2 wt % to about 15 wt %, based on a total weight of the negative active material.

An amount of the core may be about 80 wt % to about 98 wt %, based on a total weight of the negative active material.

The carbon material may include crystalline carbon, amorphous carbon, or a combination thereof.

The carbon material may include crystalline carbon.

The crystalline carbon may include natural graphite, artificial graphite, or a combination thereof.

A method of preparing a negative active material, the method including mixing a carbon material, a carbon nitride, and an acid to prepare an acid-included mixture; removing the acid from the acid-included mixture to prepare a mixture; and heat-treating the mixture.

The acid may include sulfuric acid, hydrochloric acid, nitric acid, or a combination thereof.

The heat-treatment may be performed under an inert atmosphere including nitrogen, argon, or a combination thereof.

The heat-treatment may be performed at about 300° C. to about 900° C.

The carbon nitride may be derived from a precursor including urea, melamine, dicyanamide, thiourea, cyanamide, or a combination thereof.

The carbon nitride may be prepared by preliminarily heat-treating the precursor.

The preliminarily heat-treatment may be performed at about 200° C. to about 700° C.

The embodiments may be realized by providing a rechargeable lithium battery, including a negative electrode including the negative active material; a positive electrode; and an electrolyte.

The negative electrode may further include a silicon negative active material.

The negative electrode may include the negative active material as a first negative active material and may further include the silicon negative active material as a second negative active material, and a mixing ratio of the first negative active material and the second negative active material may be about 99:1 to about 50:50 by weight ratio.

The silicon negative active material may include Si, a Si—C composite, SiOₓ (0<x<2), a Si-Q alloy (wherein Q is an alkali metal, an alkaline earth metal, a Group 13 element, a Group 14 element, a Group 15 element, a Group 16 element, a transition metal, a rare earth element, or a combination thereof, but not Si), or a combination thereof.

### BRIEF DESCRIPTION OF THE DRAWING

Features will become apparent to those of skill in the art by describing in detail exemplary embodiments with reference to the attached drawing in which:

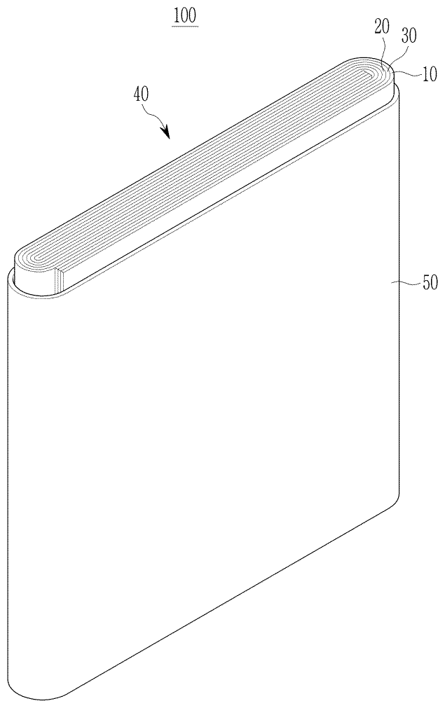

the FIG. 1s an exploded perspective view of a rechargeable lithium battery according to one or more embodiments.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing FIGURE, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Expressions in the singular include expressions in plural unless the context clearly indicates otherwise. The term “combination thereof may include a mixture, a laminate, a complex, a copolymer, an alloy, a blend, a reactant of constituents.

The terms “comprise”, “include” or “have” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

The terms “about” and “substantially” used throughout the present specification refer to the meaning of the mentioned with inherent preparation and material permissible errors when presented, and are used in the sense of being close to or near that value. They are used to help understand the present invention and to prevent unconscientious infringers from unfairly exploiting the disclosure where accurate or absolute values are mentioned.

As used herein, A and/or B indicates A or B or both of them. As used herein, the term “or” is not an exclusive term, e.g., “A or B” would include A, B, or A and B

The term “thickness” may be measured through a photograph taken with an optical microscope such as a scanning electron microscope, for example.

As used herein, when a definition is not otherwise provided, a particle diameter may be an average particle diameter. Such a particle diameter indicates an average particle diameter (D50) where a cumulative volume is about 50 volume % in a particle size distribution. If a particle has a spherical shape, a diameter indicates a particle diameter or average particle diameter, and if a particle has a non-spherical shape, a diameter indicates a length of a longer axis or an average length of a longer axis. The average particle diameter (D50) may be measured by a suitable method, for example, by a particle size analyzer, or by a transmission electron microscopic image, a scanning electron microscopic, or field emission scanning electron microscopy (FE-SEM). In some embodiments, a dynamic light-scattering measurement device may be used to perform a data analysis, and the number of particles is counted for each particle size range, and from this, the average particle diameter (D50) value may be easily obtained through a calculation, or a laser diffraction method. The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of 60 W, and calculating an average particle diameter (D50) in the 50% standard of particle distribution in the measuring device.

An active mass may represent a solid mixture of an active material, a binder, and optionally, a conductive material. In an implementation, the active mass may indicate an active material layer.

A negative active material according to one or more embodiments may include a core including a carbon material and carbon nitride on a surface of the core.

In some embodiments, the carbon nitride may be represented by Chemical Formula 1.

CₓN_{y} [Chemical Formula 1]
(wherein, 0<x<6, and 0<y<5)

The carbon nitride may be, e.g., C₃N₄, CN, C₂N, C₃N, C₂N₂, C₂N₃, C₅N, C₅N₂, or a combination thereof.

This carbon nitride may promote a lithium ion intercalation reaction and serve as a transport pathway for lithium ions. In an implementation, the carbon nitride may be located on the surface of the carbon material core, and the lithium transport pathway that promotes the intercalation reaction of the lithium ions during charging and discharging may be formed, through which the lithium ions may be rapidly inserted into the carbon material core.

The carbon nitride may reduce the interface resistance occurring on the surface of the carbon material core. Carbon materials may have large interface resistance on the surface, and the insertion reaction of lithium ions could occur slowly, causing precipitating of lithium metal on the surface. In an implementation, the carbon nitride may reduce the interface resistance, thus helping address the lithium metal precipitation. The deteriorating of fast charging characteristics and cycle-life characteristics due to this precipitation may be effectively prevented. Resultantly, the negative electrode active material according to some example embodiments may exhibit improved high-rate charging characteristics and cycle-life characteristics.

This effect may be obtained by a carbon nitride including both carbon and nitrogen. In an implementation, a metal nitride or semi-metal nitride such as aluminum nitride or silicon nitride, rather than carbon nitride, may be used, the metal nitride or semi-metal nitride may have too low electron conductivity, e.g., surprisingly high resistance (e.g., AlN: 10¹⁴ (2 cm/Si₃N₄: 10¹⁴ (2 cm), and the aforementioned effects may not be achieved.

In an implementation, the metal carbide may be located in a layer form wherein the metal carbides may be continuously present or an island form wherein the metal carbides may be discontinuously present.

In an implementation, an amount of the carbon nitride may be, based on 100 wt % (e.g., a total weight) of the negative active material, e.g., about 2 wt % to about 20 wt %, or about 2 wt % to about 15 wt %. Maintaining the amount of the carbon nitride within the above ranges may help ensure better fast charge/discharge characteristics and cycle-life characteristics are exhibited.

Such a carbon nitride may be derived from a precursor including, e.g., urea, melamine, dicyanamide, thiourea, cyanamide, or a combination thereof. In an implementation, the carbon nitride may be derived from these precursors, and these precursors, including nitrogen in a large amount, may help readily prepare carbon nitride by a simple process of merely heat-treatment.

In some embodiments, the carbon material included in the core may be, e.g., crystalline carbon, amorphous carbon, or a combination thereof. In some embodiments, the carbon material included in the core may be, e.g., crystalline carbon. The crystalline carbon may be unspecified shaped, sheet-shaped, flake-shaped, sphere-shaped, or fiber-shaped natural graphite, artificial graphite or combination thereof. The amorphous carbon may be soft carbon, hard carbon, a mesophase pitch carbonization product, calcined coke, or a combination thereof.

In some example embodiments, an amount of the core may be, based on 100 wt % of the total amount of the negative electrode active material, e.g., about 80 wt % to about 98 wt % or about 85 wt % to about 98 wt %. In an implementation, since the core may be made of a carbon material, the content of the core may mean the content of the carbon material.

In an implementation, the carbon material may have a particle diameter, e.g., an average particle diameter (D50), of about 3 μm to about 20 μm, or about 5 μm to about 15 μm. Maintaining the carbon material particle diameter within these ranges may help ensure an advantage of shortening the pathway of transporting the lithium ions inside the carbon material and between themselves. In an implementation, the core may be formed of the carbon material having a particle diameter within the ranges, and the core also may have a particle diameter within the ranges.

In some embodiments, the carbon nitride may be located, e.g., coated on the surface of the carbon material, which may be confirmed through an X-ray Photoelectron Spectroscopy (XPS) regarding carbon and nitrogen elements. In an implementation, if an XPS analysis is conducted for the negative active material according to one or more embodiments, it may be seen from a peak related to N Is appearing at a binding energy of about 390 eV to about 405 eV and a peak related to C Is appearing at a binding energy of about 285 eV to about 290 eV.

The carbon nitride located on the surface of the carbon material may be detected through an SEM photograph or a result of EDS (energy dispersive spectroscopy).

A negative active material according to some embodiments may be prepared by mixing the carbon material, the carbon nitride, and an acid to prepare an acid-included mixture; removing the acid from the acid-included mixture to prepare a mixture; and heat-treating the resulting mixture. Hereinafter, each procedure will be illustrated in more detail.

1) The carbon material, the carbon nitride, and an acid may be mixed to prepare an acid-included mixture. In some embodiments, the carbon nitride and the acid may be previously mixed and then the carbon material may be added thereto.

The mixing may be carried out at, e.g., about 30° C. to about 90° C., or about 40° C. to about 80° C.

Regardless of the order of addition, in the acid-included mixture, a mixing ratio of the carbon and the carbon nitride may be adjusted so that the carbon material and the carbon nitride are present at a weight ratio of, e.g., about 98:2 to about 80:20.

The acid may be a strong acid, e.g., sulfuric acid, hydrochloric acid, nitric acid, or a combination thereof. The acid may be used as an acid solution at a concentration of, e.g., about 30 wt % to about 80 wt %, e.g., about 50 wt % to about 70 wt %. The solvent may be water. Maintaining the concentration of the acid within the ranges may help ensure that the carbon nitride may be appropriately positioned on the surface of the carbon material core.

The carbon nitride may be derived from a precursor including, e.g., urea, melamine, dicyanamide, thiourea, cyanamide, or a combination thereof. In an implementation, these precursors may be heat-treated under an inert atmosphere to prepare carbon nitride. The heat-treatment may be carried out at, e.g., about 200° C. to about 700° C., or about 300° C. to about 650° C. The heat-treatment may be carried out for, e.g., about 1 hour to about 10 hours, or about 3 hours to 7 hours.

The inert atmosphere may be, e.g., nitrogen (N₂), argon (Ar), or a combination thereof.

2) From the obtained acid-included mixture, the acid may be removed to prepare a mixture. The removal of the acid may be performed by using a centrifuge. The removal of the acid may additionally use a solvent, and the solvent may be water. In an implementation, this process may be performed by centrifuging to remove the acid which may be separated as an upper layer and further washing with water.

3) The resulting mixture may be heat-treated to prepare a negative active material.

Before heat-treating, the resulting mixture may be further dried. The drying may be carried out under a condition which is sufficient to evaporate the solvent from the resulting mixture. In an implementation, the resulting mixture may be dried at, e.g., about 50° C. to about 120° C., or about 60° C. to about 110° C. for about 10 hours to about 15 hours.

The heat-treatment may be carried out at, e.g., about 300° C. to about 900° C., or about 350° C. to about 600° C. In an implementation, the heat-treatment may be carried out by increasing a temperature at an increasing rate of about 1° C./minute to about 10° C./minute to the above temperature, and heat-treating at that temperature.

The heat-treatment may be carried out for, e.g., about 1 hour to about 10 hours, or about 2 hours to about 7 hours. The heat-treatment may be performed under an inert atmosphere, e.g., nitrogen (N₂), argon (Ar), or a combination thereof.

Some example embodiments may provide a rechargeable lithium battery including a negative electrode, a positive electrode, and an electrolyte. The negative electrode may include a negative electrode current collector and a negative electrode active material layer on at least one surface of the negative electrode current collector. The negative electrode active material layer may include the negative electrode active material according to some example embodiments. In an implementation, as the negative electrode active material, the negative electrode active material according to some example embodiments may be included as a first active material, and a silicon negative electrode active material may be included as a second active material. A mixing ratio of the first negative electrode active material and the second negative electrode active material may be, e.g., about 99:1 to about 50:50 in weight ratio, or about 95:5 to about 80:20 in weight ratio.

The silicon active material may be, e.g., Si, a Si—C composite, SiOₓ (0<x<2), a Si-Q alloy (wherein Q may be an alkali metal, an alkaline earth metal, a Group 13 element, a Group 14 element, a Group 15 element, a Group 16 element, a transition metal, a rare earth element, or a combination thereof, but not Si), or the like, and a mixture of at least one of these elements and SiO₂ may be used. The element Q may be, e.g., Mg, Ca, Sr, Ba, Ra, Sc, Y, Ti, Zr, Hf, Rf, V, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

In an implementation, the Si—C composite may be, e.g., a form of silicon particles and amorphous carbon coated on the surface of the silicon particles. In an implementation, the silicon-carbon composite may include secondary particles into which primary silicon particles are assembled and an amorphous carbon coating layer on the surface of the secondary particles.

The amorphous carbon may be, e.g., located or coated between the silicon primary particles. In an implementation, the silicon-carbon composite may include a core where the silicon particles are dispersed in an amorphous carbon matrix and an amorphous carbon coating layer coated on the surface of the core.

The secondary particles may be located in the center of the Si—C composite, which may be referred to as the core and a center portion. The amorphous carbon coating layer may be referred to as a shell or an outer portion.

The silicon particles may be silicon nanoparticles. The silicon nanoparticles may have a particle diameter of, e.g., about 10 nm to 1,000 nm, and according to some example embodiments, it may be about 20 nm to about 900 nm, about 20 nm to about 800 nm, about 20 nm to about 500 nm, about 20 nm to about 300 nm, or 20 nm to 150 nm. Maintaining the average particle diameter of the silicon particles within the above ranges, may help ensure that excessive volume expansion occurring during charging and discharging may be suppressed, and disconnection of a conductive path due to particle crushing during charging and discharging may be prevented.

A mixing ratio of nano silicon and amorphous carbon may be, e.g., about 20:80 to about 70:30 in a weight ratio.

In an implementation, the secondary particle or the core may further include crystalline carbon. If the silicon-carbon composite further includes crystalline carbon, the Si—C composite may include secondary particles in which primary silicon particles and crystalline carbon are assembled, and an amorphous carbon coating layer on the surface of the secondary particles.

In an implementation, the Si—C may include silicon particles, crystalline carbon, and amorphous carbon, a content of the amorphous carbon may be, e.g., about 30 wt % to about 70 wt %, based on 100 wt % of the total Si—C composite, and a content of the crystalline carbon may be about 1 wt % to about 20 wt %, based on 100 wt % of the total Si—C composite. An amount of the silicon particles may be about 20 wt % to about 69 wt %, based on 100 wt % of the total Si—C composite, and according to some example embodiments, it may be about 30 wt % to about 60 wt %.

In an implementation, the amorphous carbon may be disposed while surrounding the secondary surface, and its thickness may be appropriately adjusted, but may exist in a thickness of, e.g., about 5 nm to about 100 nm.

The amount of the anode active material may be 95 wt % to 99 wt %, based on the total weight of the anode active material layer.

The negative active material layer further includes a binder, and optionally, may further include a conductive material. The amount of the binder may be 1 wt % to 5 wt %, based on the total weight of the negative active material layer. If the conductive material is further included, 90 wt % to 98 wt % of the anode active material, 1 wt % to 5 wt % of the binder, and 1 wt % to 5 wt % of the conductive material may be included.

The binder may help attach the negative electrode active material particles to each other and also help to attach the negative electrode active material to the current collector. The binder may be, e.g., a non-aqueous binder, an aqueous binder, or a combination thereof.

The non-aqueous binder may include, e.g., an ethylene propylene copolymer, polyacrylonitrile, polystyrene, polyvinylchloride, carboxylated polyvinylchloride, polyvinyl fluoride, polyurethane, polytetrafluoroethylene, polyvinylidene fluoride, polyethylene, polypropylene, polyamideimide, polyimide or combination thereof.

The aqueous binder may include, e.g., a styrene-butadiene rubber (SBR), an acrylated styrene-butadiene rubber (ABR), an acrylonitrile-butadiene rubber, an acrylic rubber, a butyl rubber, a fluoro rubber, an ethylene oxide-containing polymer, polyvinylpyrrolidone, polypropylene, polyepichlorohydrin, polyphosphazene, an ethylene propylene diene copolymer, polyvinyl pyridine, chlorosulfonated polyethylene, latex, a polyester resin, an acrylic resin, a phenol resin, an epoxy resin, polyvinyl alcohol, or a combination thereof.

The negative binder may be or include a cellulose compound, and this cellulose compound which may impart viscosity, may be used together with the aqueous binder. The cellulose compound may include, e.g., carboxymethyl cellulose, hydroxypropyl methyl cellulose, methyl cellulose, or alkali metal salts thereof. The alkali metal may be, e.g., Na, K, or Li. The cellulose compound may help impart viscosity and may be referred to as a thickener and may serve as a binder and may be referred to as a binder. The cellulose compound may be used in an appropriate amount within the amount of the binder, e.g., it may about 0.1 parts by weight to about 3 parts by weight based on 100 parts by weight of the negative active material.

Examples of the conductive material may be a carbon material, e.g., such as natural graphite, artificial graphite, carbon black, acetylene black, ketjen black, channel black, furnace black, lamp black, thermal black, a carbon fiber, or the like; a metal material of a metal powder or a metal fiber including copper, nickel, aluminum, silver, or the like; a conductive polymer such as a polyphenylene derivative; or a mixture thereof.

The current collector may include, e.g., a copper foil, a nickel foil, a stainless steel foil, a titanium foil, a nickel foam, a copper foam, a polymer substrate coated with a conductive metal, and a combination thereof.

The positive electrode may include a current collector and a positive active material layer formed on the current collector.

The positive electrode active material may include lithiated intercalation compounds that reversibly intercalate and deintercalate lithium ions. In some embodiments, one or more composite oxides of a metal, e.g., cobalt, manganese, nickel, or a combination thereof, and lithium, may be used. In an implementation, the compounds represented by one of the following chemical formulae may be used. LiₐA_{1-b}X_{b}D¹₂ (0.90≤a≤1.8, 0≤b≤0.5); LiₐA_{1-b}X_{b}O_{c2-1}D¹_{c1} (0.90≤a≤1.8, 0≤b≤0.5, 0≤c1≤0.05); LiₐE_{1-b}X_{b}O_{2-c1}D¹_{c1} (0.90≤a≤1.8, 0≤b≤0.5, 0≤c1≤0.05); LiₐE_{2-b}X_{b}O_{4-c1}D¹_{c1} (0.90≤a≤1.8, 0≤b≤0.5, 0≤c1≤0.05); LiₐNi_{1-b-c}Co_{b}X_{c}D¹_{α} (0.90≤a≤1.8, 0≤b≤0.5, 0≤c≤0.5, 0≤a≤2); LiₐNi_{1-b-c}Co_{b}X_{c}O_{2-α}T_{α} (0.90≤a≤1.8, 0≤b≤0.5, 0≤c≤0.5, 0<α<2); LiₐNi_{1-b-c}Co_{b}X_{c}O_{2-α}T₂ (0.90≤a≤1.8, 0≤b≤0.5, 0≤c≤0.5, 0<α<2); LiₐNi_{1-b-c}Mn_{b}X_{c}D¹_{α} (0.90≤a≤1.8, 0≤b≤0.5, 0≤c≤0.5, 0<α≤2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8)

In the above chemical formulars, A may be, e.g., Ni, Co, Mn, or combinations thereof; X may be, e.g., Al, Ni, Co, Mn, Cr, Fe, Mg, Sr, V, a rare earth element, and combinations thereof; D′ may be, e.g., O, F, S, P, or combinations thereof; E may be, e.g., Co, Mn, or combinations thereof; T may be, e.g., F, S, P, or combinations thereof; G may be, e.g., Al, Cr, Mn, Fe, Mg, La, Ce, Sr, V, or combinations thereof; Q may be, e.g., Ti, Mo, Mn, or combinations thereof; Z may be, e.g., Cr, V, Fe, Sc, Y, or combinations thereof; J may be, e.g., V, Cr, Mn, Co, Ni, Cu, or combinations thereof; L′ may be, e.g., Mn, Al, or combinations thereof.

The compounds may have a coating layer on the surface, or may be mixed with another compound having a coating layer. The coating layer may include at least one coating element compound, e.g., an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include, e.g., Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, and, e.g., the method may include any coating method such as spray coating, dipping, or the like.

In the positive electrode, a content of the positive active material may be about 90 wt % to about 98 wt %, based on the total weight of the positive active material layer. In an implementation, the positive active material layer may further include a binder and a conductive material.

The binder may help improve binding properties of positive active material particles with one another and with a current collector, and the binder may be, e.g., polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, an acrylated styrene butadiene rubber, an epoxy resin, nylon, or the like.

Examples of the conductive material may include a carbon material, e.g., natural graphite, artificial graphite, carbon black, acetylene black, ketjen black, a carbon fiber or the like; a metal material of a metal powder or a metal fiber including copper, nickel, aluminum, silver, or the like; a conductive polymer, e.g., a polyphenylene derivative; or a mixture thereof. The current collector may include, e.g., Al.

The negative electrode and the positive electrode may be prepared, e.g., by mixing the active material, the conductive material, and the binder in a solvent to prepare an active material composition and coating the composition on the current collector. The solvent may include, e.g., N-methyl pyrrolidone, or the like. If the aqueous binder is used in the negative electrode, the solvent used for preparing a negative active material composition may be water.

The electrolyte may include a non-aqueous organic solvent and a lithium salt.

The non-aqueous organic solvent may serve as a medium for transmitting ions taking part in the electrochemical reaction of a battery. The non-aqueous organic solvent may include, e.g., a carbonate, ester, ether, ketone, alcohol, or aprotic solvent.

The carbonate solvent may include, e.g., dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like, the ester solvent may include methyl acetate, ethyl acetate, n-propyl acetate, dimethyl acetate, methyl propionate, ethyl propionate, γ-butylolactone, decanolide, valerolactone, mevalonolactone, caprolactone, or the like. The ether solvent may include, e.g., dibutyl ether, tetraglyme, diglyme, dimethoxyethane, 2-methyltetrahydrofuran, 2,5-dimethyltetrahydrofuran, tetrahydrofuran, or the like, and the ketone solvent may include cyclohexanone, or the like. The alcohol solvent may include, e.g., ethyl alcohol, isopropyl alcohol, or the like, and examples of the aprotic solvent may include nitriles such as R—CN (where R may be a C2 to C20 linear, branched, or cyclic hydrocarbon, and may include a double bond, an aromatic ring, or an ether bond), amides, e.g., dimethylformamide, dioxolanes, e.g., as 1,3-dioxolane, 1,4-dioxolane, sulfolanes, or the like.

The organic solvent may be used alone or in a mixture. If the organic solvent is used in a mixture, the mixture ratio may be controlled in accordance with a desirable battery performance.

If the non-aqueous organic solvent is mixed and used, a mixed solvent of a cyclic carbonate and a chain carbonate, a mixed solvent of a cyclic carbonate and a propionate solvent, or a mixed solvent of a cyclic carbonate, a chain carbonate, and a propionate solvent may be used. The propionate solvent may be, e.g., methyl propionate, ethyl propionate, propyl propionate, or a combination thereof.

If the cyclic carbonate and the chain carbonate or the cyclic carbonate and the propionate solvent are mixed, they may be mixed in a volume ratio of, e.g., about 1:1 to about 1:9 and thus performance of an electrolyte may be improved. If the cyclic carbonate, the chain carbonate, and the propionate solvent are mixed, they may be mixed in a volume ratio of, e.g., about 1:1:1 to about 3:3:4. The mixing ratios of the solvents may be appropriately adjusted according to desirable properties.

The organic solvent may further include an aromatic hydrocarbon solvent as well as the carbonate solvent. The carbonate solvent and aromatic hydrocarbon solvent may be mixed together in a volume ratio of, e.g., about 1:1 to about 30:1.

The aromatic hydrocarbon organic solvent may be an aromatic hydrocarbon compound represented by Chemical Formula 1.

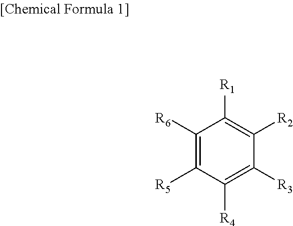

In Chemical Formula 1, R₁ to R₆ may be the same or different and may be, e.g., hydrogen, a halogen, a C1 to C10 alkyl group, a haloalkyl group, or a combination thereof.

In an implementation, the aromatic hydrocarbon organic solvent may be, e.g., benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte may further include, e.g., vinylethylene carbonate, vinylene carbonate, or an ethylene carbonate compound represented by Chemical Formula 2 as an additive for improving cycle life.

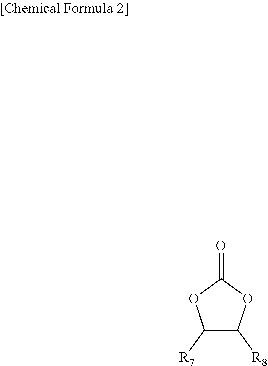

In Chemical Formula 2, R₇ may be R₈ are the same or different and, e.g., may each be independently hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not simultaneously hydrogen.

In an implementation, the ethylene carbonate compound may be, e.g., difluoro ethylene carbonate, chloroethylene carbonate, dichloroethylene carbonate, bromoethylene carbonate, dibromoethylene carbonate, nitroethylene carbonate, cyanoethylene carbonate, fluoroethylene carbonate, or the like. An amount of the additive for improving the cycle-life characteristics may be used within an appropriate range.

The lithium salt dissolved in an organic solvent may supply a battery with lithium ions, basically operate the rechargeable lithium battery, and improve transportation of the lithium ions between a positive electrode and a negative electrode. In an implementation, the lithium salt may include at least one or two supporting salts, e.g., LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂) (C_{y}F_{2y+1}SO₂), wherein x and y are natural numbers, e.g., an integer of about 1 to about 20, lithium difluoro (bisoxolato) phosphate), LiCl, LiI, LiB(C₂O₄)₂ (lithium bis(oxalato) borate (LiBOB) or lithium difluoro (oxalato)borate (LiDFOB). A concentration of the lithium salt may range from, e.g., about 0.1 M to about 2.0 M. If the lithium salt is included at the above concentration range, an electrolyte may have excellent performance and lithium ion mobility due to optimal electrolyte conductivity and viscosity.

A separator may be between the positive electrode and the negative electrode depending on a type of a rechargeable lithium battery. The separator may use, e.g., polyethylene, polypropylene, polyvinylidene fluoride or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, or the like.

The separator may further include a coating layer on at least one side thereof. The coating layer may include ceramic. The ceramic may include, e.g., SiO₂, Al₂O₃, Al (OH)₃, AlO(OH), TiO₂, BaTiO₂, ZnO₂, Mg(OH)₂, MgO, Ti(OH)₄, ZrO₂, aluminum nitride, silicon carbide, boron nitride, or a combination thereof.

The coating layer may be a functional layer having additional functions. The functional layer may be, e.g., at least one of a heat-resistance layer and an adhesive layer. The heat-resistance layer may include a heat-resistance resin and optionally a filler. The adhesive layer may include an adhesive resin and optionally a filler. The filler may be, e.g., an organic filler, an inorganic filler, or combinations thereof. The heat-resistance resin, the adhesive, and a filler resin may be any materials which may be used in the separator in the related art.

The rechargeable lithium battery may be, e.g., a lithium ion battery, a lithium ion polymer battery, or a lithium polymer battery depending on the types of the separator and the electrolyte, may be classified into, e.g., a cylindrical, prismatic, coin-type, or pouch-type depending on the shape, and may be classified into, e.g., a bulk type or a thin film type depending on a size.

The FIGURE is an exploded perspective view of a rechargeable lithium battery according to an embodiment. In an implementation, as illustrated in the drawing FIGURE, the rechargeable lithium battery may be a prismatic battery or may include variously-shaped batteries such as a cylindrical battery, a pouch battery, or the like.

As illustrated in the FIGURE, a rechargeable lithium battery 100 according to one or embodiment may include an electrode assembly 40 manufactured by winding a positive electrode 10, and a negative electrode 20, and a separator 30 disposed between the positive electrode 10 and the negative electrode 20 and a case 50 housing the electrode assembly 40. An electrolyte may be impregnated in the positive electrode 10, the negative electrode 20, and the separator 30.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Comparative Example 1

Artificial graphite with an average particle diameter of 12 μm was used as a negative electrode active material.

The negative electrode active material, a styrene-butadiene rubber, and carboxymethyl cellulose in a weight ratio of 96:2:2 were mixed in a distilled water solvent, preparing negative electrode active material slurry. This negative electrode active material slurry was coated on a 75 μm-thick copper current collector and then, dried at 80° C. and roll-pressed. Subsequently, a product therefrom was dried at 80° C. for 12 hours, manufacturing a negative electrode. The negative electrode had a loading level of 7.5 mg/cm² and an active mass density of 1.5 g/cc.

The negative electrode, a lithium metal counter electrode, and an electrolyte were used in manufacturing a coin-type half-cell. The electrolyte was a 1 M LiPF₆ solution in a mixed solvent of ethylene carbonate and dimethyl carbonate (in a volume ratio of 3:7).

### Example 1

10 g of melamine powder was heat-treated in a box-type electric furnace of 550° C. for 4 hours under an N₂ atmosphere to prepare a carbon nitride, C₃N₄.

0.1 g of carbon nitride was added to a beaker in which 40 ml of an aqueous solution with a 70 wt % concentration of nitric acid was stored, and agitated for 3 hours on a hot plate which was set to 70° C. The agitated product was added with 5 g of artificial graphite and a further agitating was carried out for 6 hours.

From the resulting product, the acid was removed using distilled water and a centrifuge, and dried in an oven set to 80° C. for 12 hours.

The dried product was placed in a calcination furnace, where the temperature was increased to 450° C. at an increasing rate of 5° C./minute, and then heat-treated at 450° C. for 3 hours under an N₂ atmosphere to prepare a negative active material. The prepared negative electrode active material included an artificial graphite core and C₃N₄ on the surface of the artificial graphite, wherein an amount of C₃N₄ was 2 wt %, based on 100 wt % of a total amount of the negative electrode active material.

A negative electrode and a half-cell were fabricated in the same manner as in Comparative Example 1 except that the negative electrode active material was used.

### Example 2

A negative electrode active material was prepared in the same manner as in Example 1 except that 0.25 g of carbon nitride was used instead of 0.1 g of carbon nitride. The prepared negative electrode active material included an artificial graphite core and carbon nitride on the surface of the artificial graphite, wherein an amount of carbon nitride was 5 wt %, based on 100 wt % of a total amount of the negative electrode active material.

A negative electrode and a half-cell were fabricated in the same manner as in Comparative Example 1 except that the negative electrode active material was used.

### Example 3

A negative electrode active material was prepared in the same manner as in Example 1 except that 0.5 g of carbon nitride was used instead of 0.1 g of carbon nitride. The prepared negative electrode active material included an artificial graphite core and carbon nitride on the surface of the artificial graphite, wherein an amount of carbon nitride was 10 wt %, based on 100 wt % of a total amount of the negative electrode active material.

A negative electrode and a half-cell were fabricated in the same manner as in Comparative Example 1 except that the negative electrode active material was used.

### Example 4

A negative electrode active material was prepared in the same manner as in Example 1 except that 1 g of carbon nitride was used instead of 0.1 g of carbon nitride. The prepared negative electrode active material included an artificial graphite core and carbon nitride on the surface of the artificial graphite, wherein an amount of carbon nitride was 20 wt %, based on 100 wt % of a total amount of the negative electrode active material.

A negative electrode and a half-cell were fabricated in the same manner as in Comparative Example 1 except that the negative electrode active material was used.

### Comparative Example 2

A negative electrode active material was prepared in the same manner as in Example 1 except that 0.1 g of silicon nitride was used instead of 0.1 g of carbon nitride. The prepared negative electrode active material included an artificial graphite core and silicon nitride on the surface of the artificial graphite, wherein an amount of silicon nitride was 2 wt %, based on 100 wt % of a total amount of the negative electrode active material.

A negative electrode and a half-cell were fabricated in the same manner as in Comparative Example 1 except that the negative electrode active material was used.

### Experimental Example 1) Evaluation of Fast Charge

The half-cells according to Examples 1 to 4 and Comparative Examples 1 to 2 were charged and discharged at a voltage range of 0.01V to 1.5V vs. Li/Li⁺ under the following conditions: 1 C charge/0.5 C discharge once, 2 C charge/0.5 C discharge once, 3 C charge/0.5 C discharge once, 4 C charge/0.5 C discharge once, 5 C charge/0.5 C discharge once, 6 C charge/0.5 C discharge once, and 2 C charge/0.2 C discharge once.

Based on charge capacity at 1 C, a ratio of charge capacity at each C-rate was calculated. The results are shown in Table 1, as a fast chargeability (high-rate charge rate).

TABLE 1

| | 2 C charge | 3 C charge | 4 C charge | 5 C charge | 6 C charge |
|---|---|---|---|---|---|
| | rate (%) | rate (%) | rate (%) | rate (%) | rate (%) |
| Example 1 | 61.4 | 27.4 | 13.9 | 6.9 | 5.0 |
| Example 2 | 54.2 | 23.2 | 13.5 | 6.5 | 4.6 |
| Example 3 | 46.0 | 20.0 | 12.7 | 5.8 | 4.2 |
| Example 4 | 45.3 | 19.3 | 12.3 | 5.3 | 4.0 |
| Comparative | 41.7 | 16.8 | 10.4 | 4.3 | 3.1 |
| Example 1 | | | | | |
| Comparative | 42.4 | 17.9 | 10.6 | 3.1 | 2.5 |
| Example 2 | | | | | |

As shown in Table 1, the half-cells of Examples 1 to 4 including the negative active materials with carbon nitride on their surface, exhibited surprisingly excellent fast chargeability at 2 C to 6 C, compared with Comparative Examples 1 and 2 including the negative active materials without carbon nitride.

Whereas, the cell including the negative active material where silicon nitride was located (Comparative Example 2) exhibited slightly similar to or worse results than Comparative Example 1.

### Experimental Example 2) Evaluation of Impedance

The half-cells according to Examples 1 to 4 and Comparative Examples 1 to 2 were, in the voltage range of 0.01 V to 1.5 V vs. Li/Li⁺, subjected to 0.05 C charge/0.05 C discharge once, and then were subjected to 0.05 C charge under SoC 50 (charge may refer to charging the battery to be 50% of charge capacity based on 100% of total battery charge capacity and discharge may refer to discharging the battery to be 50% of discharge capacity based on 100% of entire battery discharge capacity). Impedance for the charged cell was measured by an EIS (electrochemical impedance spectroscopy) method. The range for measuring the impedance was set to 0.5 MHz to 1 MHz. The results, i.e. electrolyte internal resistance (bulk resistance, Rb), resistance by a SEI layer formed on the negative electrode (RSEI), and charge transfer resistance (Rct) are shown in Table 2.

TABLE 2

| | R_{b} (Ω) | R_{SEI} (Ω) | Rct (Ω) |
|---|---|---|---|
| Example 1 | 1.5 | 2.0 | 3.8 |
| Example 2 | 1.2 | 2.1 | 7.3 |
| Example 3 | 1.2 | 4.3 | 12.9 |
| Example 4 | 1.2 | 4.4 | 13.5 |
| Comparative Example 1 | 1.4 | 4.9 | 14.8 |
| Comparative Example 2 | 1.8 | 4.8 | 17.5 |

As shown in Table 2, the half-cells according to Examples 1 to 4 including the negative active materials of which the surface was positioned with carbon nitride exhibited surprisingly low resistance compared to Comparative Example 1 including the negative active material without carbon nitride.

Whereas, the cell including the negative active material where silicon nitride was located (Comparative Example 2) exhibited slightly similar to or higher resistance than Comparative Example 1.

By way of summation and review, one or more embodiments may provide a negative active material exhibiting improved fast charging and cycle-life characteristics. Another embodiment may provide a rechargeable lithium battery including the negative active material. Additionally, a negative active material according to some embodiments may exhibit excellent fast charge and cycle-life characteristics.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative active material, comprising:
a core comprising a carbon material; and
a carbon nitride on a surface of the core.

2. The negative active material as claimed in claim 1, wherein the carbon nitride is represented by Chemical Formula 1,
CₓN_{y} [Chemical Formula 1]
wherein 0<x<6 and 0<y<5.

3. The negative active material as claimed in claim 1, wherein the carbon nitride comprises C₃N₄, CN, C₂N, C₃N, C₂N₂, C₂N₃, C₅N, C₅N₂ or a combination thereof.

4. The negative active material as claimed in claim 1, wherein an amount of the carbon nitride is about 2 wt % to about 20 wt %, based on a total weight of the negative active material.

5. The negative active material as claimed in claim 1, wherein an amount of the carbon nitride is about 2 wt % to about 15 wt %, based on a total weight of the negative active material.

6. The negative active material as claimed in claim 1, wherein an amount of the core is about 80 wt % to about 98 wt %, based on a total weight of the negative active material.

7. The negative active material as claimed in claim 1, wherein the carbon material comprises crystalline carbon, amorphous carbon, or a combination thereof.

8. The negative active material as claimed in claim 1, wherein the carbon material comprises crystalline carbon.

9. The negative active material as claimed in claim 8, wherein the crystalline carbon comprises natural graphite, artificial graphite, or a combination thereof.

10. A method of preparing a negative active material, the method comprising:
mixing a carbon material, a carbon nitride, and an acid to prepare an acid-included mixture;
removing the acid from the acid-included mixture to prepare a mixture; and
heat-treating the mixture.

11. The method of preparing a negative active material as claimed in claim 10, wherein the acid comprises sulfuric acid, hydrochloric acid, nitric acid, or a combination thereof.

12. The method of preparing a negative active material as claimed in claim 10, wherein the heat-treatment is performed under an inert atmosphere comprising nitrogen, argon, or a combination thereof.

13. The method of preparing a negative active material as claimed in claim 10, wherein the heat-treatment is performed at about 300° C. to about 900° C.

14. The method of preparing a negative active material as claimed in claim 10, wherein the carbon nitride is derived from a precursor comprising urea, melamine, dicyanamide, thiourea, cyanamide, or a combination thereof.

15. The method of preparing a negative active material as claimed in claim 14, wherein the carbon nitride is prepared by preliminarily heat-treating the precursor.

16. The method of preparing a negative active material as claimed in claim 15, wherein the preliminarily heat-treatment is performed at about 200° C. to about 700° C.

17. A rechargeable lithium battery, comprising:
a negative electrode comprising the negative active material as claimed in claim 1;
a positive electrode; and
an electrolyte.

18. The rechargeable lithium battery as claimed in claim 17, wherein the negative electrode further comprises a silicon negative active material.

19. The rechargeable lithium battery as claimed in claim 18, wherein:
the negative electrode comprises the negative active material as a first negative active material and further comprises the silicon negative active material as a second negative active material, and
a mixing ratio of the first negative active material and the second negative active material is about 99:1 to about 50:50 by weight ratio.

20. The rechargeable lithium battery as claimed in claim 18, wherein the silicon negative active material comprises Si, a Si—C composite, SiOₓ, in which 0<x<2, a Si-Q alloy, in which Q is an alkali metal, an alkaline earth metal, a Group 13 element, a Group 14 element, a Group 15 element, a Group 16 element, a transition metal, a rare earth element, or a combination thereof, but not Si, or a combination thereof.
